(19) United States
(12) Patent Application Publication
(10) Pub. No.: US 2013/0256433 A1
(43) Pub. Date: Oct. 3, 2013

(54) Strobed Spray Nozzle Illuminator

(71) Applicant: Gary E. Gunthorpe, Calgary (CA)

(72) Inventor: Gary E. Gunthorpe, Calgary (CA)

(21) Appl. No.: 13/851,160

(22) Filed: Mar. 27, 2013

(30) Foreign Application Priority Data
Mar. 27, 2012 (CA) 2773087

(51) Int. Cl. A01G 25/09

(52) U.S. Cl. CPC A01G 25/09
USPC 239/726; 239/289

(57) ABSTRACT

A spraying apparatus includes a nozzle connected to a pressurized liquid supply and dispensing a spray pattern from a discharge orifice of the nozzle A stroboscopic light source is mounted on one side of the nozzle and directs a pulsating light beam along the spray pattern such that the spray pattern is stroboscopically illuminated and visible to an operator on the opposite side of the nozzle. Continuous light can also be provided to illuminate the spraying apparatus for night operations.

### CROSS-REFERENCE TO RELATED APPLICATIONS

This application claims the benefit of priority under 35 U.S.C. §119 from Canadian Patent Application Serial No. 2773087, filed on Mar. 27, 2012, which is hereby incorporated by reference as if fully set forth herein.

### BACKGROUND

This invention is in the field of agricultural implements and in particular sprayer implements for applying chemicals to crops.

The agriculture industries use large sprayer implements to spray agricultural chemicals such as herbicides, pesticides, fungicides, and the like onto the fields. Such sprayer implements are disclosed for example in U.S. Pat. Nos. 7,669,784 to Sobolik and 7,669,675 to Hagie. These implements are very wide and may have more than 100 spray nozzles. Before each use, each nozzle should be inspected to determine if they have the proper spray pattern and volume. Currently this is typically done with hand held flow meters, held individually under each nozzle as it sprays water. This process is very time consuming, and as a result this inspection is often not carried out.

U.S. Pat. Nos. 4,023,507 to van der Lely and 4,193,356 to Vehe et al. disclose a ground working implement with a spray boom and nozzles where sensors such as probes and cameras are connected to indicators such as lights or screens to inform the operator when spray nozzles are dispensing liquid.

A field sprayer nozzle pattern monitor is disclosed in U.S. Pat. No. 4,905,897 to Rogers et al. A sensor head is clamped onto the nozzle cap by way of a slot which receives the fin of the nozzle cap. The sensor includes a mouth which receives sound from the spray nozzle and transmits it to a microphone, and a central processor unit receives signals from each sensor and compares these with a predetermined calibration signal to determine which nozzles are blocked or faulty.

U.S. Pat. No. 7,311,004 to Giles discloses a process for monitoring fluid flow through a nozzle using a vibration sensor mounted to the nozzle. The vibration output is analyzed to determine whether or not the nozzle is operating properly.

A significant amount of spraying is performed in the dark to take advantage of the quieter winds at dawn and dusk; illumination is required to allow the operator to see the area being sprayed. This illumination is typically provided by spot lights however it is difficult to view the outer ends of the sprayer boom, which could be 100 or more feet wide. A significant amount of power is drawn by conventional spot lights as well.

### SUMMARY OF THE INVENTION

It is an object of the embodiments of the present disclosure to provide a sprayer apparatus that overcomes problems in the prior art.

The present invention provides a sprayer apparatus which allows the operator to visually verify that each nozzle is providing the appropriate pattern and volume. It is known that a stroboscopic light can provide a visual stop motion effect. This effect is used by the invention to achieve the desired inspections. This invention replaces the spot lights with LED's which can provide either the stroboscopic or continuous illumination.

In a first embodiment the present disclosure provides a spraying apparatus comprising a nozzle connected to a pressurized liquid supply and dispensing a spray pattern from a discharge orifice of the nozzle, and a stroboscopic light source mounted on a first side of the nozzle and directing a pulsating light beam along the spray pattern such that the spray pattern is stroboscopically illuminated and visible to an operator on an opposite second side of the nozzle.

In a second embodiment the present disclosure provides an agricultural spraying apparatus comprising a sprayer boom mounted on a vehicle for movement along the ground in a forward operating travel direction, the sprayer boom extending laterally substantially perpendicular to the forward operating travel direction. A pressurized liquid supply directs pressurized liquid along the sprayer boom to a plurality of nozzles attached to the sprayer boom such that a spray pattern is dispensed downward from a discharge port of each nozzle. A stroboscopic light source is mounted on a first side of each nozzle and directs a pulsating light beam along the spray pattern of each nozzle such that the spray pattern is stroboscopically illuminated and visible to an operator on an opposite second side of each nozzle.

The present disclosure provides the operator with essentially a “stopped” image of the spray pattern so that anomalies can be seen and corrected as necessary. Continuous light can also be provided to illuminate the spraying apparatus for night operations.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic view of electrical circuits for providing the light source and control thereof in a spraying apparatus;

FIG. 2 is a schematic front view of an embodiment of a spraying apparatus of the disclosure;

FIG. 3 is a schematic side view of the spraying apparatus of FIG. 2;

FIG. 4 is a schematic top view of an agricultural spraying implement with the spraying apparatus of FIG. 2 incorporated thereon;

FIG. 5 is a schematic view of the agricultural spraying implement of FIG. 4.

### DETAILED DESCRIPTION OF THE ILLUSTRATED EMBODIMENTS

The drawings illustrate an embodiment of a spraying apparatus comprising a nozzle connected to a pressurized liquid supply and dispensing a spray pattern from a discharge orifice of the nozzle. A stroboscopic light source is mounted on a first side of the nozzle and directs a pulsating light beam along the spray pattern such that the spray pattern is stroboscopically illuminated and visible to an operator on an opposite second side of the nozzle.

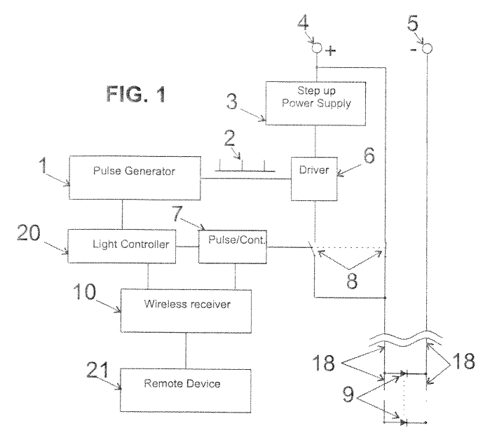

FIG. 1 shows a schematic of the electronics circuits for providing the stroboscopic light source where the light source is provided by an array of light emitting diodes (LEDs) 9. Electrical direct current power from is connected via the plus connector 4 and the negative connector 5. A voltage step up power supply 3 increases the voltage above the rated voltage of the LEDs 9 to drive higher currents than normal to the pulsating LEDs 9 and provide a brighter light beam. A pulse generating circuit 1 produces a waveform 2 which contains a plurality of narrow on pulses separated by long off pulses. This waveform 2 cause the driver circuit 6 to gate the voltage from the step up power supply 3 through the pulse/continuous selector switch 8 on to the cable 18 which is connected to the LED's 9. The selector switch 8 may be manually changed to provide a direct connection from the plus power connector 4 to the cable 18 then on to the LED's 9, thus providing a continuous light output at the rated voltage of the LEDs if it is desired to view the spray pattern 17 continuously.

A wireless receiver circuit 10 may be provided which allows a remote device 21 to connect to a light controller 20 to control the duration of the on pulses via the pulse generator 1 and to control the selector switch 8 via the pulse/continuous circuit 7.

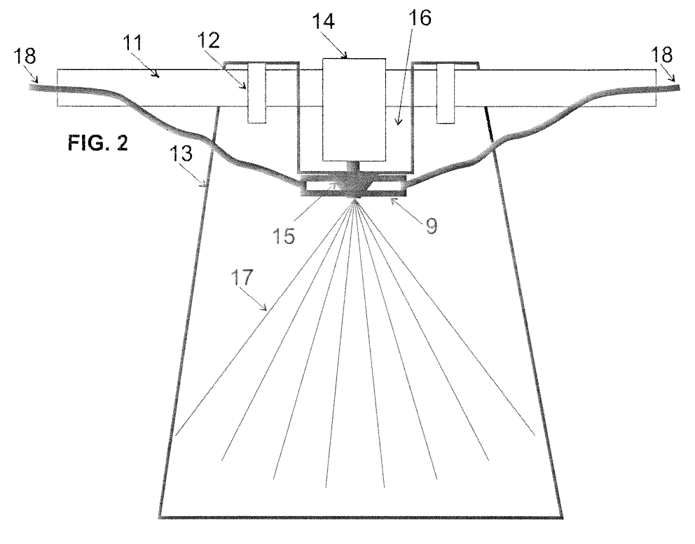

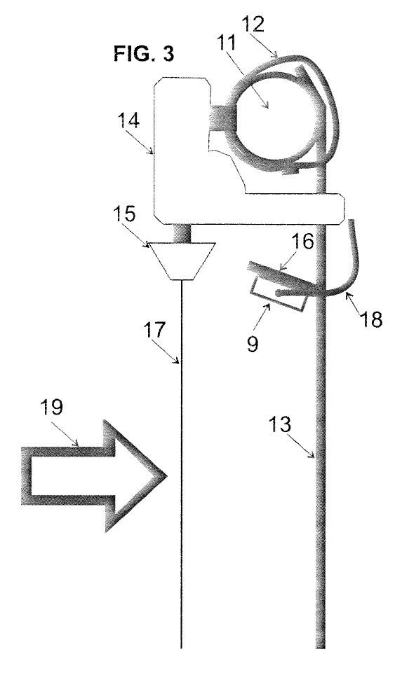

FIGS. 2 and 3 show, respectively, front and side views of the LED 9 mounting system. A dark colored non-reflective shield 13 is strapped onto the liquid delivery pipe 11 with elastic, Velcro, or tie wrap binding straps 12 such that the LED 9 is between the shield 13 and the spray pattern 17. A tab 16 is arranged to form a mounting tab for the LED 9. Cables 18 deliver either pulsed or continuous power to the LED 9. Pressurized liquid flows from the delivery pipe 11 through the nozzle holder 14 then through the spray nozzle 15 thus producing the illuminated spray pattern 17. The stroboscopic light source provided by the LED 9 on a first side of the nozzle 15 directs the pulsating light beam along the spray pattern 17 and stroboscopically illuminates the spray pattern 17 to an operator 19 on an opposite second side of the nozzle 15. The LED 9 illuminates the back of the spray pattern 17 thus allowing the operator to view the shape and form of the spray pattern 17.

The pulse generating circuit 1 is adjusted so the LED is turned on for an on period and is turned off for an off period to create the pulsating light beam, and a light controller 20 can be operative to adjust an on duration of the on period and an off duration of the off period. In a typical operation the on period may be 100 microseconds and the off duration may be 1000 milliseconds. LEDs typically will have a rated operating voltage but since the LEDs are off for the great majority of the time, the light controller 20 can be operative to provide a voltage at the LEDs that is above the rated operating voltage when the light beam is pulsating, thus increasing the light output for a brighter illumination. Due to the brief on period the LED's current can be driven at several times their rating thus significantly enhancing the brightness of the strobe. When continuous illumination is desired, the switch 8 can be activated manually or by the light controller 20 to turn the at least one LED on continuously, and the voltage at the LED for continuous operation will bet the rated operating voltage.

The dark colored non-reflective shield provides contrast and improves the visibility of the spray pattern, especially in brighter ambient light conditions. The shield may also provide some protection from wind, which can distort the spray pattern 17.

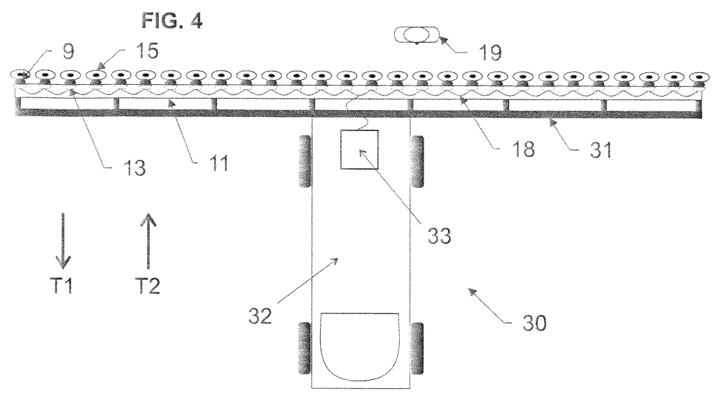

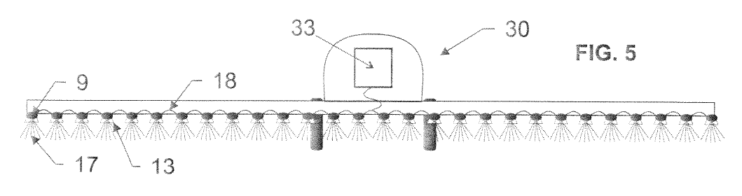

FIGS. 4 and 5 schematically illustrate the stroboscopic illumination used in an agricultural spraying apparatus 30 comprising a sprayer boom 31 mounted on a vehicle 32 for movement along the ground. The sprayer boom 31 extends laterally substantially perpendicular to the operating travel direction. In some types of spraying apparatuses 30 the operating travel direction will be in direction T1 such that the sprayer boom 31 is at the rear of the apparatus 30, and in others the operating travel direction will be in direction T2 such that the sprayer boom will be at the front of the apparatus 30. The schematically illustrated apparatus 30 may operate in either direction

A pressurized liquid supply 33 directs pressurized liquid along the sprayer boom 31 to a plurality of nozzles 15 attached to the sprayer boom 31 such that a spray pattern 17 is dispensed downward from a discharge port of each nozzle 15.

A stroboscopic light source, LEDs 9, powered through cable 18, is mounted on a first side of each nozzle 15 and directs a pulsating light beam along the spray pattern 17 of each nozzle 15 such that the spray pattern 17 is stroboscopically illuminated and visible to an operator 19 standing on the opposite second side of the nozzles 15.

A dark colored non-reflective shield 13 extends downward such that each light source 9 is between a shield 13 and the corresponding spray pattern 17 dispensed by the nozzle 15. In the illustrated spraying apparatus 30, a small reflective shield 13 is attached to the sprayer boom adjacent to each light source 9 and extends downward.

Thus to check the spray patterns 17 the operator will typically fill the sprayer tank with water and stand beside the spraying apparatus 30 in location 19 and move along the boom 31 to view a stopped” image of each spray pattern so that anomalies can be seen and corrected as necessary. In order to reduce the amount of water required, remote controlled valves may be provided so that the operator can turn sections of nozzles 15, such as 10-15 nozzles at a time, on and off while walking along behind the boom 31.

The present invention provides the operator an image of the spray pattern, and can also be used to provide light for operations at night.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A spraying apparatus comprising:
a nozzle connected to a pressurized liquid supply and dispensing a spray pattern from a discharge orifice of the nozzle;
a stroboscopic light source mounted on a first side of the nozzle and directing a pulsating light beam along the spray pattern such that the spray pattern is stroboscopically illuminated and visible to an operator on an opposite second side of the nozzle.

2. The apparatus of claim 1 wherein the light source is provided by at least one light emitting diode (LED).

3. The apparatus of claim 2 wherein the at least one LED is turned on for an on period and is turned off for an off period to create the pulsating light beam, and comprising a light controller operative to adjust an on duration of the on period and an off duration of the off period.

4. The apparatus of claim 3 wherein the at least one LED has a rated operating voltage, and wherein the light controller is operative to turn the at least one LED on continuously at the rated operating voltage.

5. The apparatus of claim 3 wherein the at least one LED has a rated operating voltage and wherein the light controller is operative to provide a voltage at the at least one LED that is above the rated operating voltage when the light beam is pulsating.

6. The apparatus of claim 3 wherein the light controller is activated by a wireless remote control.

7. The apparatus of claim 2 wherein the light source is provided by a plurality of LEDs.

8. The apparatus of claim 1 comprising a dark colored non-reflective shield located such that the light source is between the shield and the spray pattern, such that the operator views the spray pattern against the shield.

9. An agricultural spraying apparatus comprising:
a sprayer boom mounted on a vehicle for movement along the ground in a forward operating travel direction, the sprayer boom extending laterally substantially perpendicular to the forward operating travel direction;
a pressurized liquid supply directing pressurized liquid along the sprayer boom to a plurality of nozzles attached to the sprayer boom such that a spray pattern is dispensed downward from a discharge port of each nozzle;
a stroboscopic light source on a first side of each nozzle and directing a pulsating light beam along the spray pattern of each nozzle such that the spray pattern is stroboscopically illuminated and visible to an operator on an opposite second side of each nozzle.

10. The apparatus of claim 9 wherein the light source is provided by a light emitting diode (LED).

11. The apparatus of claim 10 wherein the LED is turned on for an on period and is turned off for an off period to create the pulsating light beam, and comprising a light controller operative to adjust an on duration of the on period and an off duration of the off period.

12. The apparatus of claim 11 wherein the LED has a rated operating voltage, and wherein the light controller is operative to turn the LED on continuously at the rated operating voltage.

13. The apparatus of claim 11 wherein the LED has a rated operating voltage and wherein the light controller is operative to increase a voltage at the at least one LED above the rated operating voltage when the light beam is pulsating.

14. The apparatus of claim 10 wherein the light source is provided by a plurality of LEDs.

15. The apparatus of claim 10 comprising a dark colored non-reflective shield located relative to each light source such that each light source is between the shield and the corresponding spray pattern, such that the operator views each spray pattern against the shield.
